(19) United States
(12) Patent Application Publication
(10) Pub. No.: US 2015/0172374 A1
(43) Pub. Date: Jun. 18, 2015

(54) MOBILE CONTENT TRANSFER (MCT) SOLUTION

(71) Applicant: Synchronoss Technologies, Inc., Bridgewater, NJ (US)

(72) Inventors: Omar Chaudhry, Oak Brook, IL (US); Alexander Chow, Campbell, CA (US); Robert Hanaway, Bryanstown (IE); Rajesh S. Khandewale, Sunnyvale, CA (US); Patrick Lennon, Dublin 2 (IE)

(21) Appl. No.: 14/542,051

(22) Filed: Nov. 14, 2014

Related U.S. Application Data
(60) Provisional application No. 61/917,297, filed on Dec. 17, 2013.

(51) Int. Cl. H04L 29/08; H04W 4/00; H04L 12/24

(52) U.S. Cl. CPC H04L 67/10; H04L 41/02; H04W 4/008

(57) ABSTRACT

A Mobile Content Transfer (MCT) system requires no special equipment or a physical connection to any hardware. The MCT system has no hardware limitation with regard to the number of simultaneous transfers. The MCT system can be used to transfer data from anywhere at any time by anyone without the need to go into a retail location. The MCT system can transfer and store all or some data classes to increase adoption and usage of the MNO Cloud. The MCT system eliminates the need for dedicated personnel allowing more personnel to attend to new sales revenue opportunities. The MCT system eliminates the need to wait for a single machine or individual and empowers the end-user to perform the transfer of their data whenever and wherever they choose. The MCT system provides the option to safely and securely store data in the cloud that can be restored to another device.

### CROSS-REFERENCE TO RELATED APPLICATION(S)

This application claims priority under 35 U.S.C. §119(e) of the U.S. Provisional Patent Application Ser. No. 61/917,297, filed Dec. 17, 2013 and titled, “MOBILE CONTENT” which is also hereby incorporated by reference in its entirety for all purposes.

### FIELD OF THE INVENTION

The present invention relates to the field of content transfer. More specifically, the present invention relates to content transfer for a mobile device.

### BACKGROUND OF THE INVENTION

Previous implementations of content transfer had many limitations such as: no simple means of transferring content to a new device; current legacy equipment is capable of only one transfer at a time which leads to long lines if multiple users are waiting for their content to be transferred; special equipment that is expensive to acquire and requires specially trained personnel to operate which also requires custom cables and a yearly maintenance fee; and current transfer methods do not promote the use and growth of the MNO Cloud and do not allow the end-user the ability to provide a permanent backup of their content.

### SUMMARY OF THE INVENTION

The MCT system requires no special equipment or a physical connection to any hardware. It is simple and developed for anyone to use. The MCT system has no hardware limitation with regard to the number of simultaneous transfers. The MCT system can be used to transfer data from anywhere at any time by anyone without the need to go into a retail location. The MCT system can transfer and store all or some data classes to increase adoption and usage of the MNO Cloud. This will help promote the use and growth of the MNO Cloud. The MCT system eliminates the need for dedicated personnel allowing more personnel to attend to new sales revenue opportunities. The MCT system eliminates the need to wait for a single machine or individual and empowers the end-user to perform the transfer of their data whenever and wherever they choose. The MCT system provides the option to safely and securely store data in the cloud that can be restored to another device.

### BRIEF DESCRIPTION OF THE DRAWINGS

FIG. 1 illustrates a flowchart of a method of implementing the MCT system according to some embodiments.

FIG. 2 illustrates a block diagram of an exemplary computing device configured to implement the MCT system according to some embodiments.

FIG. 3 illustrates a network of devices configured to implement the MCT system according to some embodiments.

### DETAILED DESCRIPTION OF THE PREFERRED EMBODIMENT

A Mobile Content Transfer (MCT) system is a solution that supports the migration of a user's mobile content from and existing (old) device to a different (new) device when upgrading or switching devices. The MCT system is a solution utilizing cloud-based infrastructure and/or peer to peer connection to provide a content transfer capability that is available for use by retail store sales associates of a wireless carrier, Mobile Network Operator (MNO), retailer, as well as to a wireless end-user using the on-device client software-based User Interface (UI). The MCT system can be accessed and used at the point of sale (such as in a retail store) or at home by the subscriber.

The MCT client system supports any operating system such as: Android, iOS, Windows Phone, Blackberry and Tizen. The MCT client system supports many content classes such as: Contacts, Call Logs, SMS, MMS, Photos, Video, Music and Documents.

The MCT system described herein improves and solves all of the current limitations of the available solutions. The MCT system requires no special equipment or a physical connection to any hardware. It is simple and developed for anyone to use. The MCT system has no hardware limitation with regard to the number of simultaneous transfers. The MCT system can be used to transfer data from anywhere at any time by anyone without the need to go into a retail location. The MCT system can transfer and store all or some data classes to increase adoption and usage of the MNO Cloud. This will help promote the use and growth of the MNO Cloud. The MCT system eliminates the need for dedicated personnel allowing more personnel to attend to new sales revenue opportunities. The MCT system eliminates the need to wait for a single machine or individual and empowers the end-user to perform the transfer of their data whenever and wherever they choose. The MCT system provides the option to safely and securely store data in the cloud temporarily or permanently that can be restored to another device.

The MCT system can also recommend applications to be installed on the new device based on the applications that are installed on the old device. This is used primarily when switching across platforms (e.g. from or to Android, iOS, WPB, BB10, Tizen). Suggestions are presented after the summary screen with a link to each application that directs the user to the respective application store. In some embodiments, application widgets are placed on the device and when clicked will redirect the end-user to the application store. Once downloaded and installed, the widget will launch the application.

The MCT system can transfer settings (e.g. notifications sounds, wallpaper, lock screen, Wi-Fi AP, localization, Bluetooth, Accounts and other information).

The MCT system implements “touch, transfer and go,” so that touching devices together using Near-Field Communication (NFC) initiates pairing and transferring via Bluetooth, Wi-Fi AP, Wi-Fi Direct/Hotspot or WWAN.

The MCT system enables syncing content from/to 3rd party providers (e.g., Box, Dropbox, Google Drive).

The MCT system enables a user to clone his device. The MCT application will clone the end-user's old device and copy all content, settings and personalization to his new device. When holding the old device next to the new device, they will appear almost identical when transferring across the same platform and similar when transferring across different platforms. A clone of the device can be stored in the cloud with ongoing daily backups to ensure if the original device is lost, stolen or damaged, all of the content, settings and personalization can be restored to a new device.

MCT is also able to assist in the valuation of the old device for trade-in. The MCT system, during the transfer, assesses the functionality of the old device by running a series of diagnostic tests to determine the value of the device. In some embodiments, a sales representative also grades the device visually and provides a score. The user is presented with tentative value for his old device and can either leave his device at the retail location or be mailed out a mailing label to send the old device back.

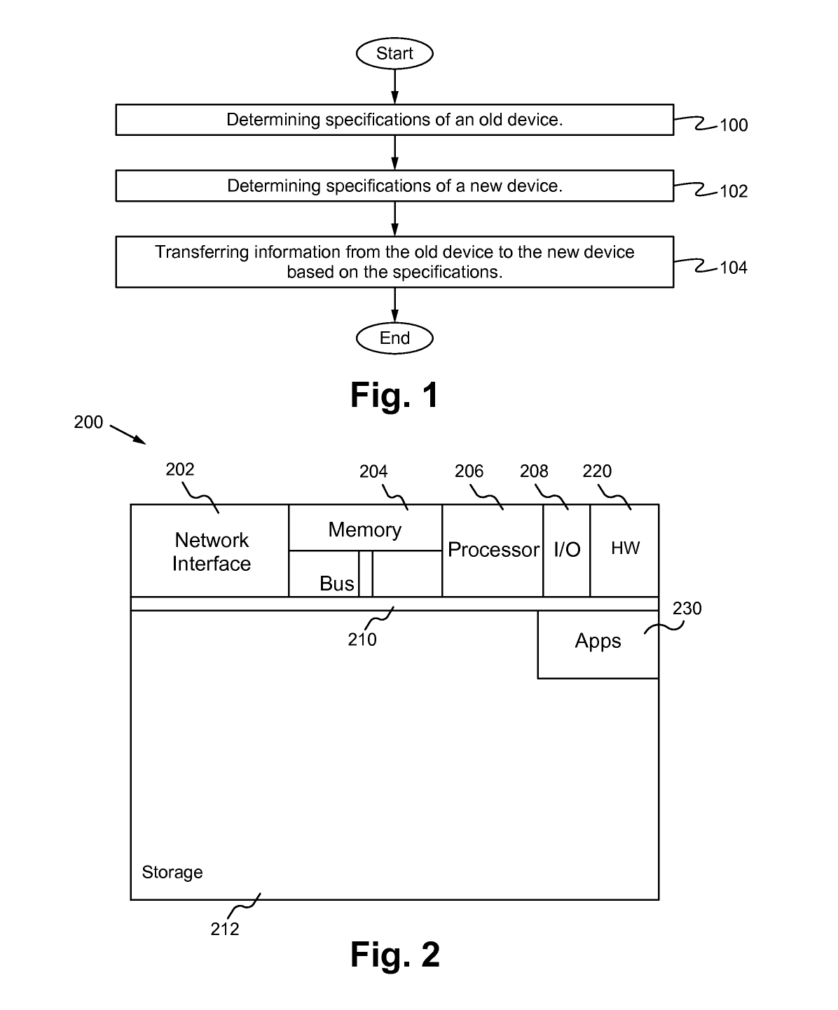

FIG. 1 illustrates a flowchart of a method of implementing the MCT system according to some embodiments. In the step 100, the MCT system determines the specifications of an old device (e.g., the device the user is switching from). The specifications include any information usable for transferring information such as model of the device, operating system, applications, settings, and other information. The specifications are able to be determined in any manner such as analyzing the device, performing a system scan of the device or looking up the specifications of the device in a database. In the step 102, the MCT system determines the specifications of a new device (e.g., the device the user is switching to). The specifications include any information usable for transferring information such as model of the device, operating system, applications, settings, and other information. The specifications are able to be determined in any manner such as analyzing the device, performing a system scan of the device or looking up the specifications of the device in a database. In the step 104, based on the analysis of the old device and the new device, information (e.g., settings information, content) is transferred and/or modified so that the new device replicates the old device. In some embodiments, the information is transferred to a cloud device from the old device and then to the new device. In some embodiments, additional steps are implemented such as recommending applications for the new device based on applications on the old device, syncing content, and determining the value of the old device. In some embodiments, the order of the steps is modified. Any of the steps described herein are able to be performed automatically or manually.

There are several implementations of transferring data/content/settings from a first device to a second device. The information can be transferred directly (e.g., first phone to second phone). The information can be transferred via the Cloud (e.g., first phone to cloud device to second phone). The can be transferred using an access point, which is also referred as peer to peer (e.g., first phone to access point to second device).

FIG. 2 illustrates a block diagram of an exemplary computing device configured to implement the MCT system according to some embodiments. The computing device 200 is able to be used to acquire, store, compute, process, communicate and/or display information. For example, a computing device 200 is an old device, a new device, a cloud device or any other device. In general, a hardware structure suitable for implementing the computing device 200 includes a network interface 202, a memory 204, a processor 206, I/O device(s) 208, a bus 210 and a storage device 212. The choice of processor is not critical as long as a suitable processor with sufficient speed is chosen. The memory 204 is able to be any conventional computer memory known in the art. The storage device 212 is able to include a hard drive, CDROM, CDRW, DVD, DVDRW, Blu-Ray®, flash memory card or any other storage device. The computing device 200 is able to include one or more network interfaces 202. An example of a network interface includes a network card connected to an Ethernet or other type of LAN. The I/O device(s) 208 are able to include one or more of the following: keyboard, mouse, monitor, display, printer, modem, touchscreen, button interface and other devices. In some embodiments, the hardware structure includes multiple processors and other hardware to perform parallel processing. MCT system application(s) 230 used to perform the MCT method are likely to be stored in the storage device 212 and memory 204 and processed as applications are typically processed. More or fewer components shown in FIG. 2 are able to be included in the computing device 200. In some embodiments, MCT hardware 220 is included. Although the computing device 200 in FIG. 2 includes applications 230 and hardware 220 for implementing the MCT method, the MCT method is able to be implemented on a computing device in hardware, firmware, software or any combination thereof. For example, in some embodiments, the MCT applications 230 are programmed in a memory and executed using a processor. In another example, in some embodiments, the MCT hardware 220 is programmed hardware logic including gates specifically designed to implement the method.

In some embodiments, the MCT application(s) 230 include several applications and/or modules. In some embodiments, modules include one or more sub-modules as well.

Examples of suitable computing devices include a personal computer, a laptop computer, a computer workstation, a server, a mainframe computer, a handheld computer, a personal digital assistant, a cellular/mobile telephone (e.g. an iPhone®), a smart appliance, a tablet computer (e.g. an iPad®), a smart watch, or any other suitable computing device.

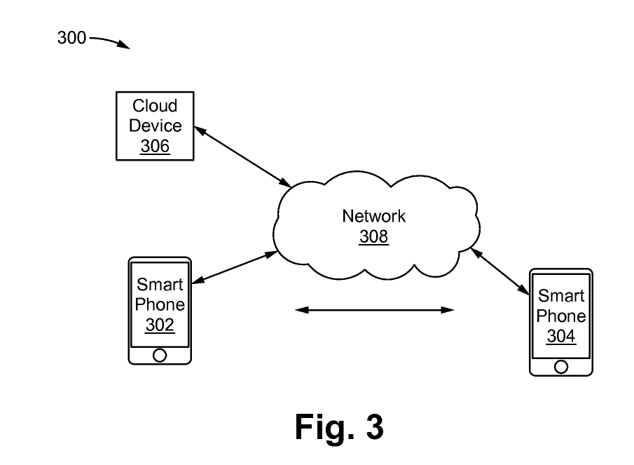

FIG. 3 illustrates a network of devices configured to implement the MCT system according to some embodiments. The network of devices 300 is able to include any number of devices and any various devices including, but not limited to, a first smart device 302 (e.g., a smart phone), a second smart device 304 and a cloud device 306 coupled through a network 308 (e.g., the Internet). The network 308 is able to be any network or networks including, but not limited to, the Internet, an intranet, a LAN/WAN/MAN, wireless, wired, cellular, Ethernet, satellite, a combination of networks, or any other implementation of communicating. The devices are able to communicate with each other through the network 308 or directly to each other.

To utilize the MCT system, information on a first device (e.g., smart phone) is detected and transferred to a second device. In some embodiments, the information is transferred through another device (e.g., a cloud device). After the transfer is complete, the second device is substantially equivalent to the first device in terms of the user's settings, applications, configurations and other personalized information.

In operation, the MCT system requires no special equipment or a physical connection to any hardware. It is simple and developed for anyone to use. The MCT system has no hardware limitation with regard to the number of simultaneous transfers. The MCT system can be used to transfer data from anywhere at any time by anyone without the need to go into a retail location. The MCT system can transfer and store all or some data classes to increase adoption and usage of the MNO Cloud. This will help promote the use and growth of the MNO Cloud. The MCT system eliminates the need for dedicated personnel allowing more personnel to attend to new sales revenue opportunities. The MCT system eliminates the need to wait for a single machine or individual and empowers the end-user to perform the transfer of their data whenever and wherever they choose. The MCT system provides the option to safely and securely store data in the cloud that can be restored to another device.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method of implementing coordinated testing programmed in a memory of a device comprising:
a. determining a first set of specifications of a first device;
b. determining a second set of specifications of a second device; and
c. transferring information from the first device to the second device based on the first set of specifications and the second set of specifications.

2. The method of claim 1 wherein transferring the information includes transferring the information from the first device to a cloud computing device and transferring the information from the cloud computing device to the second device.

3. The method of claim 1 wherein transferring the information includes transferring the information directly from the first device to the second device.

4. The method of claim 1 wherein transferring the information includes transferring the information from the first device to a cloud device and from the cloud device to the second device.

5. The method of claim 1 wherein transferring the information includes transferring the information from the first device to an access point and from the access point to the second device.

6. The method of claim 1 further comprising recommending applications to be installed on the second device based on the applications installed on the first device.

7. The method of claim 6 wherein recommending the applications occurs when a first platform of the first device is different from a second platform of the second device.

8. The method of claim 6 wherein recommending the applications includes presenting suggestions after a summary screen with a link to each application that directs a user to a respective application store.

9. The method of claim 6 wherein recommending the applications includes placing application widgets on the second device, and when clicked, the application widgets redirect a user to an application store.

10. The method of claim 1 wherein transferring the information includes transferring settings information including account information.

11. The method of claim 1 further comprising implementing Near-Field Communication to initiate pairing and transferring of the information.

12. The method of claim 1 further comprising assessing functionality of the first device by running a series of diagnostic tests to determine a value of the first device while transferring the information.

13. An apparatus comprising:
a. a non-transitory memory for storing an application, the application for automatically:
i. determining a first set of specifications of a first device;
ii. determining a second set of specifications of a second device; and
iii. transferring information from the first device to the second device based on the first set of specifications and the second set of specifications; and
b. a processing component coupled to the memory, the processing component configured for processing the application.

14. The apparatus of claim 13 wherein transferring the information includes transferring the information from the first device to a cloud computing device and transferring the information from the cloud computing device to the second device.

15. The apparatus of claim 13 wherein transferring the information includes transferring the information directly from the first device to the second device.

16. The apparatus of claim 13 wherein the application is further for: automatically recommending applications to be installed on the second device based on the applications installed on the first device.

17. The apparatus of claim 16 wherein recommending the applications occurs when a first platform of the first device is different from a second platform of the second device.

18. The apparatus of claim 16 wherein recommending the applications includes presenting suggestions after a summary screen with a link to each application that directs a user to a respective application store.

19. The apparatus of claim 16 wherein recommending the applications includes placing application widgets on the second device, and when clicked, the application widgets redirect a user to an application store.

20. The apparatus of claim 13 wherein transferring the information includes transferring settings information including account information.

21. The apparatus of claim 13 wherein the application is further for: implementing Near-Field Communication to initiate pairing and transferring of the information.

22. The apparatus of claim 13 wherein the application is further for: automatically assessing functionality of the first device by running a series of diagnostic tests to determine a value of the first device while transferring the information.

23. A system comprising:
a. a first mobile device including a first set of specifications;
b. a second mobile device including a second set of specifications, wherein information is transferred from the first device to the second device based on the first set of specifications and the second set of specifications.

24. The system of claim 23 further comprising an access point for receiving the information from the first device and transferring the information to the second device.

25. The system of claim 23 further comprising a cloud computing device for receiving and storing the information from the first device and transferring the information to the second device.

26. The system of claim 25 wherein the cloud computing device is configured for recommending applications to be installed on the second device based on the applications installed on the first device.

27. The system of claim 26 wherein recommending the applications occurs when a first platform of the first device is different from a second platform of the second device.

28. The system of claim 26 wherein recommending the applications includes presenting suggestions after a summary screen with a link to each application that directs a user to a respective application store.

29. The system of claim 26 wherein recommending the applications includes placing application widgets on the second device and when clicked the application widgets redirect a user to an application store.

30. The system of claim 25 wherein the cloud computing device is configured for transferring settings information including account information.

31. The system of claim 25 wherein the cloud computing device is configured for assessing functionality of the first device by running a series of diagnostic tests to determine a value of the first device while transferring the information.
